(19) United States
(12) Patent Application Publication
(10) Pub. No.: US 2024/0250949 A1
(43) Pub. Date: Jul. 25, 2024

(54) SYSTEM FOR PROVIDING A DIVERSITY, EQUITY, AND INCLUSION INFORMATION PLATFORM

(71) Applicant: DiverseCity, Inc., Puyallup, WA (US)

(72) Inventors: Jahmad D Canley, Puyallup, WA (US); Alexandra M Sarge, Titusville, FL (US); Jason London, Summerville, SC (US); Zachary Lesak, Ambridge, PA (US); Colton Woo, Schaumburg, IL (US)

(21) Appl. No.: 18/240,228

(22) Filed: Aug. 30, 2023

Related U.S. Application Data
(60) Provisional application No. 63/440,884, filed on Jan. 24, 2023.

(51) Int. Cl. H04L 9/40; H04L 65/1073; H04L 65/1093

(52) U.S. Cl. CPC H04L 63/104; H04L 65/1073; H04L 65/1093

(57) ABSTRACT

A system for providing a diversity, equity, and inclusion platform is disclosed. The system includes a user permissions module to assign a group, a role, and one or more permissions to each of a plurality of users within an organization. An activity module permits the creation and completion of one or more activities and a gamification module assigns a point value to each of the one or more activities. An analytics module is in operable communication with a user interface module to display metrics related to each of the plurality of users, wherein the metrics are associated with the engagement of the one or more activities.

This application claims the benefit of U.S. Provisional Patent Appl. Ser. No. 63/440,884, filed on Jan. 24, 2023.

### TECHNICAL FIELD

The embodiments generally relate to computerized information and training systems, and more particularly relate to computerized systems for providing diversity, equity, and inclusion training and information platforms.

### BACKGROUND

Intentional diversity programs can assist organizations facing demographic changes in their consumer market and/or labor force by helping groups of people work with and understand one another better. Having a culture of diversity, equity, and inclusion may aid in fostering a productive, efficient, and healthy environment for members of a group or organization. A diverse organization may promote creativity, innovation, problem solving capacity, and organizational flexibility if practices are properly implemented.

Often, groups or organizations may implement an initiative to promote diversity, equity, and inclusion using various processes. For example, an organization may perform an audit to analyze their diversity, equity, and inclusion through measurable metrics. Some training programs exist in the current arts. However, many of the known training systems focus on the dissemination of information at the individual level, rather than a collaborative small-group approach to enhancing the group or organizations diversity, equity, and inclusion initiatives.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

In general, the embodiments provided herein relate to a system for providing a diversity, equity, and inclusion information, interaction, and training platform which can be used by a group or organization. The system permits passive and/or active engagement by members of the group or organization to promote better understanding and acceptable practices related to diversity, equity, and inclusion. Via a customizable playbook and gamification, the system provides a means for guiding participants through various tasks, exercises, or to consume information provided by the system and/or its participants. The system permits participants to be dynamically separated into subgroups to allow for interaction within the subgroups as well as between subgroups. One or more individuals within the organization and/or within each subgroup may be assigned a title, permissions, responsibilities, or the like to define roles within the organization or the subgroups thereof.

One embodiment of the present invention includes an interactive information system comprising a user permissions module to assign a group, a role and one or more permissions to each of a plurality of users within an organization. An activity module can be included to permit the creation and completion of one or more activities. An analytics module in operable communication with a user interface module to display metrics related to each of the plurality of users, wherein the metrics are associated with the engagement of the one or more activities.

Another embodiment of the present invention comprises a super-admin portal including a means for configuring multiple unique instances of an interactive information system, each identified by a unique access code. A means for configuring for each instance of the interactive information system is included that comprises a user permissions module to assign a group, a role and one or more permissions to each of a plurality of users within an organization. The configurations means also comprises an activity module to permit the creation and completion of one or more activities and a gamification module to assign a point value to each of the one or more activities; and an analytics module in operable communication with a user interface module to display. The configuration means also includes metrics related to each of the plurality of users, wherein the metrics are associated with the engagement of the one or more activities.

Still another embodiment of the present invention comprises a method of configuring an interactive information system including setting a unique client access ID and assigning an application administrator. The method can also include configuring subject matter experts, uploading curated library content, configuring tags to group content by keywords, and configuring pre-defined topics and messages that can deploy to all users of the mobile application upon initial login.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the system infrastructure and connected network, according to some embodiments;

FIG. 2 illustrates a block diagram of the server engine and modules, according to some embodiments;

FIG. 3 illustrates a screenshot of the settings interface, according to some embodiments;

FIG. 4 illustrates a screenshot of the administrative settings interface, according to some embodiments;

FIG. 5 illustrates a screenshot of the playbook points assignment interface, according to some embodiments;

FIG. 6 illustrates a screenshot of the playbook activity assignment interface, according to some embodiments;

FIG. 7 illustrates a screenshot of the reward setup interface, according to some embodiments;

FIG. 8 illustrates a screenshot of the reward setup interface, according to some embodiments;

FIG. 9 illustrates a screenshot of the playbook overview interface, according to some embodiments;

FIG. 10 illustrates a screenshot of key metrics through the leaderboard interface, according to some embodiments;

FIG. 11 illustrates a screenshot of the QR code interface, according to some embodiments;

FIG. 12 illustrates a screenshot of the analytics interface, according to some embodiments; and

FIG. 13 illustrates a screenshot of the user's home interface, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a system for providing a diversity, equity, and inclusion information, interaction, and training platform which can be used by a group or organization. The system permits passive and/or active engagement by members of the group or organization to promote better understanding and acceptable practices related to diversity, equity, and inclusion. Via a customizable playbook and gamification, the system provides a means for guiding participants through various tasks, exercises, or to consume information provided by the system and/or its participants. The system permits participants to be dynamically separated into subgroups to allow for interaction within the subgroups as well as between subgroups. For example, an organization having 100 employees may be separated into ten subgroups each having ten individuals. One or more individuals within the organization and/or within each subgroup may be assigned to title, permissions, responsibilities, or the like to define roles within the organization or the subgroups thereof.

As used herein, the term “organization” may relate to businesses, workplaces, schools, school districts, colleges and universities, government agencies, communities, non-profit organizations, institutions, corporations, and any other group of individuals working or interacting directly or indirectly with one another.

The system provides an efficient solution for solving the complexities of diversity, equity, and inclusion within an organization while aiding in employee and content retention, creating privacy, and giving users more comfort when discussing or engaging difficult subjects related to diversity, equity, and inclusion. The system allows for the use of curated content from experts in the field of diversity, equity, and inclusion or can be utilized as an open-ended system where organizations can present any subject or content they desire.

The embodiments provided herein relate to a system for providing a diversity, equity, and inclusion platform. The system includes various aspects. One aspect is a web-based Super Admin portal that allows DiverseCity to set-up 1) unique client (known as a “State”) accesses and the assignment of an application administrator (known as the “Governor”), 2) subject matter experts, known as “leaders”, 3) pieces of curated content known as “library content” 4) tags and categories, used to group content by a key filtering word, 5) topics, which are pre-defined and, if desired, ordered topics for discussion once users are in the mobile application and 6) Prewritten messages or prerecorded videos that deploy to all users of the mobile application upon initial login. Five of the six noted elements, except the creation of the unique client access code, may be deployed globally, to all DiverseCity clients, or individually, via manual assignment to a specific client. Upon creation of a new client access code, the system creates the ability for the application administrator to log into a unique instance of the mobile app and continue the specific set up required. Another aspect is the mobile application, which is established as a closed mobile application system such that only users with permission or approval to enter may use the mobile app as described in further detail below. Another aspect is a web-based “Governor Set-up” website that allows the application administrator to perform the steps of setting up the unique characteristics of their State on desktop as opposed to a mobile device. The set-up then automatically updates that client's instance of the application. This is intended to provide a convenient manner to administratively update or manage the application. The overall functional premise of the application is to enable the employees within one organization to be given permission to access the application; then to be divided into groups, either manually or randomly assigned; and to study a specific topic for a set period of time. All groups study the same topic for the same period of time or “cycle”. The number of groups is predetermined based on the total number of expected users, the total number of groups the client wishes to create and the minimum number of users per group. Each group is assigned a facilitator to encourage participation and oversee the interactions between the group's members. The application has other mechanisms to encourage participation. For example, there is a set of assigned activities that each group is required to accomplish during the topic cycle. This is called a “Playbook”. The Playbook module allows for the creation of activities that all groups would be required to complete during a cycle. Within the mobile application, there are several modules that collectively provide the users with a variety of capabilities upon the assignment of various roles within the app. As mentioned above, the role of Governor acts as the overall administrator of the tool, with the following permissions within the Settings Module:

Topics: Topics can be configured in two manners—via the Super Admin website or added manually within the app. Once topics are within the app, the Governor has the capacity to decide which topics will be studied and to determine whether randomly ordered or specifically ordered.

Client Identity: within Client Identity, a client can configure how it wants to present the application to its employees. For example, the key elements of the of application are labeled as:
a. State—represents the individual client or organization for which a new, unique instance of the application has been created;
b. City—represents the small groups in which employees are placed to have discussions;
c. Governor—represents the employee of the client who has the highest administrative access within the application;
d. Mayor—represents the specific employee in a City chosen to act as facilitator for the City during a cycle;
e. Citizen—represents the individual employees or users within the State/Client.

These labels are configurable and may be changed by the Governor. As well under the Client Identity, the client can add a personalized message to all its employee and/or a unique logo.

Mode of Operation: the client can configure or choose which mode of operation it wishes to use within the application. There are two modes of operations to choose from:
a. Open Post mode: this mode is the expected mode of the application. It allows Citizens within each City to initiate new posts to the other citizens in their City.
b. Governor-Led mode: this mode may be considered a Trainer-Led mode and represents a limited posting mode where the Governor is the sole user who can initiate posts within the application. Posts initiated by the Governor are pushed to all Cities at the same time. Citizens and the Mayor of each City are allowed to respond to the post and share thoughts on the post, however these responses can only be viewed by those in the same City.

City Setup: in this area of the settings, the client can configure the number of cities (small groups) they want. By entering data into three fields, the Total number of Employees, Number of Cities and the Minimum employees per City, the application does the calculation and creates the appropriate number of cities desired. For example, if a client has 90 employees and wants 7 cities, with no less than 5 citizens in each group, the application creates 7 generic Cities into which users will be placed as they enter the app for the first time. Within City Setup, the client can also choose to have the system randomly assign citizens to the newly created Cities, OR the client can shut off that feature and manually assign each citizen to a specific city. Each City also has a mayor. The assignment of a mayor to a particular city may also be done randomly (automatically by the system) or manually by the Governor. Finally, in this area, the Governor may allow or disallow the mayor to edit certain distinguishing features of their city, such as the name or the icon/avatar. This allows the small groups to have some fun identifying themselves inside the app.

Cycle Setup: Each State operates on a periodic cycle of time, during which time the members within each city discuss the current Topic. The Topic and the amount of time to discuss that topic are the same for all cities. In Cycle Setup, the client can predetermine the number of weeks they wish to have each topic discussed. As well, the application can be set to randomly shuffle citizens at the end of a cycle, which moves them into different groups for the next topic/cycle. This may also be shut off, allowing citizens to stay in the same city during multiple cycles. At the end of each cycle, the application runs standard procedures to capture data, archive posts and clear the playbook to ready it for the next cycle. A more thorough description of the playbook is below.

Citizen (or user) Approval Setup: The Citizen Setup tells the application the manner in which new users will be approved when they enter the system for the first time. Because this application is not a public/social media platform open to anyone, permission to enter a particular client instance must be obtained. The system can be set up to “force” new citizens to be manually approved by the Governor. This would eliminate the risk of non-employees accessing the app. However, for a large organization, this would present a burdensome administrative task. To provide protection while reducing the effort, the app was designed such that the “Approve new Citizen” can be disabled but only for certain email domains, such as the client's own email server. Citizens asking to enter with a different email would still have to be approved manually. Multiple domains can be set up for this process.

Citizen Setup: Once a user/Citizen has been approved, they are either placed randomly into a City or manually assigned thereto. Once assigned, the Citizen may be appointed Mayor for a current cycle (if no Mayor has yet been assigned) or for the next cycle. Here, a Citizen may also be moved to a different city, blocked or unblocked, or deleted from the app completely (say, in the case of a terminated employee) by the Governor. Most of these tasks occur when the cycle is not active, however, some changes happen immediately based on certain criteria.

The final sub-module under State Settings is Post Settings. In this area, governors can choose if they wish to “approve new posts” or not. If enabled to approve all posts, any new post made by a citizen in a cycle will remain undisclosed to their City until the Governor approves it. As well, Governors can enable a Block List of inappropriate or sensitive words that they wish to block from being used. When a blocked word is used by a Citizen, they receive a message prohibiting them to post until they reword the post. NOTE—in some cases, the blocked word may be used intentionally, however, the app will prohibit the use of the word. Users are then given an opportunity to change or edit the word to something more appropriate. New words may be added to or deleted from the Block List at any time.

The Governor Settings area also has a sub-module called “Incidents”. Within Incidents, there is a page for Reported Posts and one for Deleted Accounts. Users of the application have the ability to report a post made by a fellow city member which the citizen finds offensive, inappropriate or inaccurate. When a post is reported, it is sent to the Governor for review. The Governor is able to discern whether to allow the post to remain or can delete it from the City's posts. NOTE—clients will be expected to have human resources policies related to the handling of such situations with the parties outside of the application. Citizens are also allowed to Delete their own account (required by app stores) and Governors can also delete a Citizen's account from the Citizen Setup. In both cases, however, this is a request only and is sent to the Governor for final approval. The governor is then given one last opportunity to restore the user or to fully remove the user from the app. This feature is important as employees leave organizations as the user count impacts pricing to the client.

The next module available to the Governor is the Playbook Setup module:

The playbook is a set of predefined activities created by the Governor and represents the set of activities each City must complete to be eligible for rewards (described below). The playbook is part of the Gamification element of the application and is intended to promote engagement by offering points for participation. The Playbook module allows for the following elements to be established for each activity:
a. Activity Type—there are several activity types within the system, each with programmed allowable response posting types. The activity types have increasing higher levels of expected engagement. For example, “Simple Interaction” allows for only a Thumbs Up/Down or a simple text post response, whereas “Leader Content” requires that the Citizen find a piece of content from the Resource Center (internal, within the app) to share with their City.
b. Activity Title—allows the governor to describe the activity to be done, which will be displayed in each City's Home and City pages. NOTE: all cities see the same playbook.
c. Points—points for engagement are assigned to each activity, presumably with higher values as the activities become more involved or require more effort.
d. Quantity of activities—indicates the number of each activity that must be completed by each City during a cycle.
e. All elements of the Playbook, except the title may only be modified when a cycle is inactive.

Rewards Module: Within the rewards module, the governor has the option to set up Badges and Prizes.
a. Badges are pre-programmed awards given to the Individual Citizen who obtains the most engagement points (those derived by participating in the posting and responding during a cycle); to the Individual Citizen who earns the most Trivia Points (Trivia is explained in further detail below) during a cycle; and to City Champions, which is the city who accumulates the most total points from its citizens during a cycle (Total Points is the sum of engagement and trivia points). In this setup area, the Governor may change the name of the Badge and create a description of the Badge. These changes are visible to all users of the app. Badges earned are archived in the Individual Citizen's profile or, in the case of the City Champion Badge, in the profiles of all the citizens in the city that earned the badge. Badges may only be modified when a cycle is inactive.
b. Prizes are an optional reward system that, when enabled, allows citizens to exchange points for prizes. The Prize Setup allows for the following parameters to be preset by the Governor:

Picture Upload—allows a picture to be uploaded from the Governors' mobile photos.

Name—what the prize will be called (i.e “Rock Star Parking”, or “Visa Gift Card”.

Prize Description—an explanation of what the prize entails.

Points Needed For This Prize—sets the point value needed to be relinquished from the Citizen's points when the prize is selected.

Quantity Available—indicates the number of times the prize is available.

Inventory Alert Level—the number of remaining prizes that would trigger an email alert.

Send Inventory Alert Email to—the email address of the person who will replenish the inventory or who needs to know that the prizes have all been claimed.

Send Prize Claim Email To—the email address of the person who will distribute the prize to the recipient. For example, an Accounting Manager may distribute Visa Gift Cards, but the Office Manager may give special parking passes.

Prizes can be monetary or non-monetary in value. New Prizes can be added at any time by the Governor.

Resources Setup: This sub-module of Settings allows the Governor to manually set up a piece of content to be shared across all cities immediately and thereafter be available in the Library page of the Resources module. The Governor can also view all the content made available in the Library. The use of this Governor Settings module will easily allow for new, organizational information to be shared easily. A good example might be a company newsletter.

Trivia Pool Setup: The creation of a Trivia function within the app was done to encourage 360-degree learning. As citizens learn more about the Topic being discussed, they have the ability to suggest that their Mayor create a Trivia Question to be submitted to the Governor. Once the submitted Trivia Question is approved, it remains in the Governor's Trivia Pool and may be sent out to all Cities as a fun way to challenge other citizens while a cycle is in play. Points are earned by answering the Trivia Question, with correct answers receiving higher points. Only Governors and Mayor have the option to create a Trivia Question when opening a new post. Because most Trivia Questions will come “from the bottom, up”, it reenforces learning and adds another dimension of friendly competition. Trivia Questions are stored in the Governor Settings and may be reused in future cycles.

The final sub-modules of Settings relate to the standard App Settings and About. App Settings allows the Governor to manage notifications (Push Notifications and Replies to my Posts”. As well, this page gives access to Support, Privacy Policy, Terms and Conditions, Change Password and to logout of the application. The “About” page gives a brief overview of the application.

The Governor Setup portal may be web-based. This website allows the governor of a client to access all elements described above and configure their instance of the application from the web rather than inside the app. The Governor must use their unique login credentials to obtain this access. All configurations are pushed to the application in real time. This function is intended to provide convenience and alternative administrative methods for clients.

In one aspect, the system provides, via gamification, a means for guiding participants through various tasks, exercises, or to consume information provided by the system and/or its participants. The system permits participants to be dynamically separated into subgroups to allow for interaction within the subgroups as well as between subgroups.

The system provides an efficient solution for solving the complexities of diversity, equity, and inclusion within an organization while aiding in employee and content retention, creating privacy, and giving users more comfort when discussing or engaging difficult subjects related to diversity, equity, and inclusion. The system allows for the use of curated content from experts in the field of diversity, equity, and inclusion or can be utilized as an open-ended system where organizations can present any subject or content they desire.

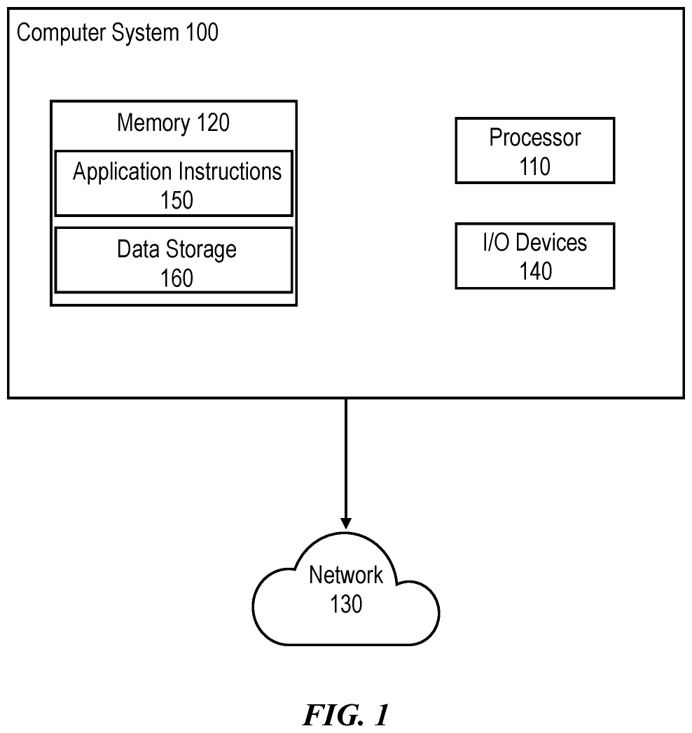

FIG. 1 illustrates a computer system 100, which may be utilized to execute the processes described herein. The computer system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile tablet device, a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C #, JAVA®, JAVASCRIPT®, PERL®, etc.).

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

A working example of the system is described. While specific examples are provided, one skilled in the arts will readily understand that alternative embodiments may be generated without differing from the spirit of the invention. Specifically, terms identifying user (or groups thereof) roles and identities such as “state”, “governor”, “mayor”, “cities”, “citizens”, and the like may be changed without deterring from the present embodiments. In one example, the system is provided in the form of a mobile application downloaded to a mobile device (e.g., a smartphone) by a member of an organization. The organization may be referred to as “The State”. The state may assign a super administrator (e.g., an HR Director/Director of Diversity Equity and Inclusion) referred to by the system as “The Governor”. The Governor may hand select the team leaders, referred to in the app as “The Mayors”. The system automatically (based on pre-set parameters such as # of employees/# of groups) may assign participants (i.e., company's employees, teachers within a school or district, volunteers, or student body) to teams or small groups which may be referred to as “The Cities” and the assigned users are “The Citizens” of that group (City).

The Governor determines the length of time the group stays together, called the “Cycle”. The start date is selected from a calendar and the end date is calculated based on predetermined length of time chosen by the Governor. The Governor assigns the cycle's topic of discussion by selecting from a pre-populated list of topics or by creating a topic manually. The topic may be internally derived based on the needs of the organization to provide a customizable approach to improving the organizations diversity, equity, and inclusion. The Cycle and the topic of discussion are typically the same for all teams. However, the Governor may make these decisions at the City level.

In some embodiments, QR code invites are sent for users to register for access to the mobile application in their City. Each city has a Mayor (i.e., team lead). The Mayor has a group of citizens/users who compete by answering trivia questions and engaging in various other specific tasks/posts/dialogue on an ongoing basis to expedite cultural awareness and inclusion. At the end of each cycle, Citizens may be automatically rotated/reassigned to a new team (“City”), based on the group size parameters determined in the Governor setup process. Users are challenged to participate through engagement that stimulates their curiosity, competition, and memory recall.

In some embodiments, Citizens receive points and rewards based on their levels of engagement and participation to be determined by the company or institution (i.e., the State). The system has a full reward platform that has an optional ability to integrate with several reward management systems.

In some embodiments, the system is able to integrate with third-party platforms including social media platforms, communications platforms, human resource systems, and the like. The system may also include the integration of various executive reports and dashboards to determine the number of key organization-defined metrics.

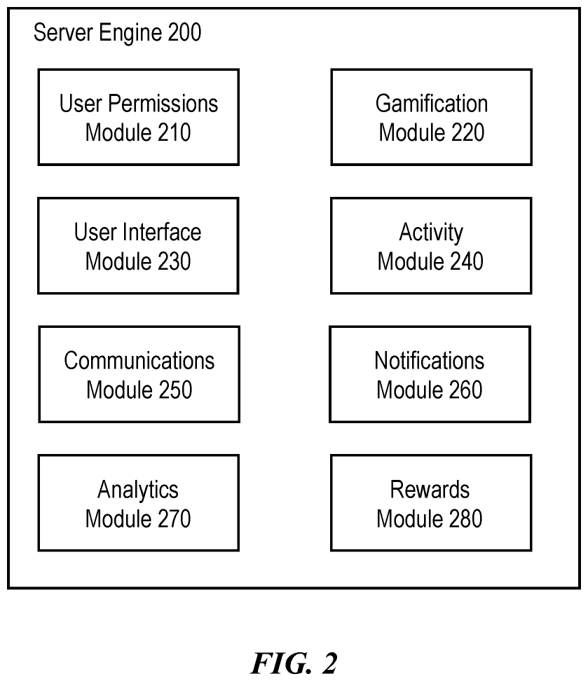

FIG. 2 illustrates a block diagram of the server engine 200 and modules including a user permissions module 210, a gamification module 220, a user interface module 230, an activity module 240, a communications module 250, a notifications module 260, an analytics module 270, and a rewards module 280. The user permissions module 210 permits user roles and permissions to be defined, such that specific users may create activities, engage in activities, evaluate user interactions, etc. The gamification module 220 permits users to engage in various games (e.g., trivia, activities, and tasks) such that users can 1) engage in friendly competition or 2) optionally, only allow the organization to track engagement without a competition feature. Activities can be created, and points may be assigned thereto. A user interface module 230 permits users to interact with the user interface provided on the display of their device. An activity module 240 permits the creation, monitoring, scoring, and execution of an activity which may or may not be gamified. A communications module 250 permits communications between users of the system while a notification module 260 generates and transmits notifications to the users. The notification module 260 may also generate a code (e.g., a QR code) which allows users to join and interact with the system. The analytics module 270 monitors user engagement with the system and provides an analytics interface which quantifies user interactions with activities and/or other users of the system. The rewards module 280 assigns a reward value to points earned by the system to incentivize the completion of activities and/or engagement with the system.

In some embodiments, the system may be in communication with an artificial intelligence engine to analyze user input. For example, the artificial intelligence engine may analyze communications between users or content submitted to the system for unacceptable language, phrases, themes, etc. The artificial intelligence engine may suggest more appropriate language, phrases, or themes before the content is published.

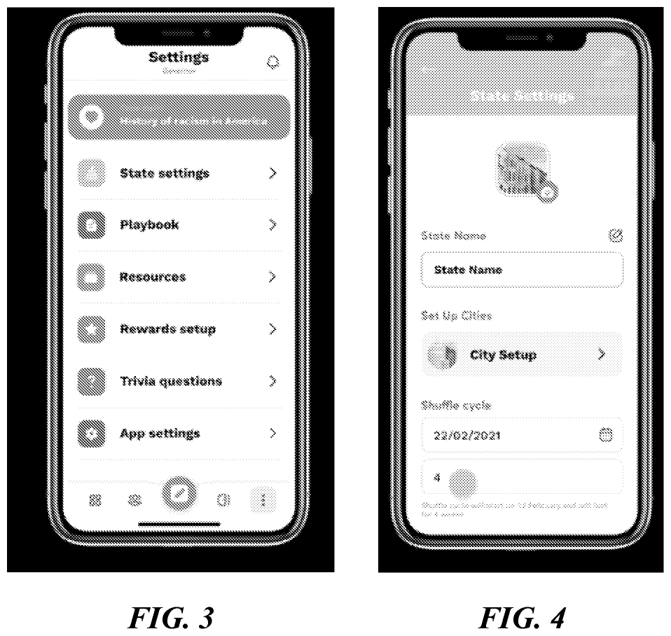

FIGS. 3-13 illustrates exemplary screenshots of the user interface associate with the diversity, equity, and inclusion platform to operate the functionalities described herein. One skilled in the arts will readily understand that the user interface depicted in the screenshots may be changed depending on the organization, goals of the organization, or strategy for enhancing the organizations diversity, equity, and inclusion practices.

FIG. 3 illustrates a screenshot of the settings interface wherein the user may select state settings, playbook settings and activities, resources, rewards, trivia questions and activities, and application settings. FIG. 4 illustrates a screenshot of the state settings interface wherein the user may input the state name, setup of cities, cycle duration, number of states and cities therein, etc.

In some embodiments, the playbook includes a list of pre-set engagement activities that may be completed by each team within each cycle. The shuffle duration, known as a “cycle”, defines a start date and end date (or number of weeks) during which each team works with one another. In some embodiments, each team/subgroup or “City” follow the same playbook and compete against one another in generating points through the completion of activities. The playbook may provide the frequency of these tasks/activities, and the point value for each time all citizens in the city complete them. The playbook may standardize what is to be completed, and the point value assigned for effort and participation.

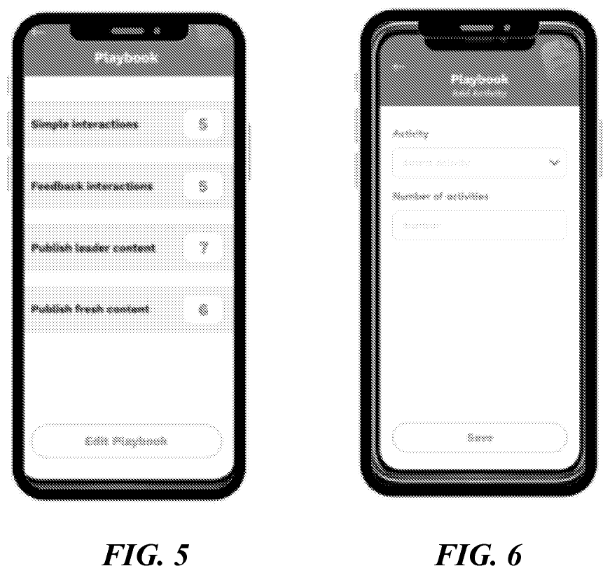

FIG. 5 illustrates a screenshot of the playbook points assignment interface wherein activities or tasks are assigned a points value. FIG. 6 illustrates a screenshot of the playbook activity assignment interface wherein activities are selected by the user. The points provide a gamified system wherein group leaders (i.e., Mayors) can submit trivia questions derived from a group discoveries and insights. Trivia questions may also be submitted by the Governor, who then can push the submitted Trivia questions out to all Cities.

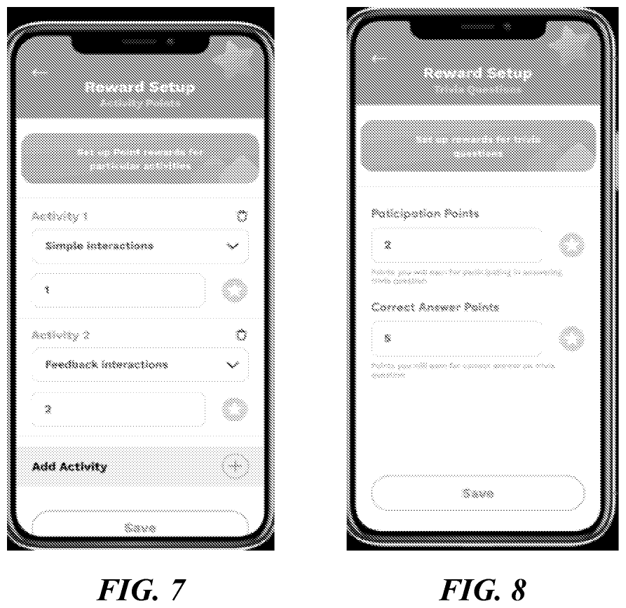

FIG. 7 and FIG. 8 illustrate the reward setup interface wherein rewards are assigned for various point values. In such, the users are incentivized for interacting with the system by communicating with other users, completing tasks or activities, etc. The rewards may include monetary rewards or items which can be earned through the accumulation of points.

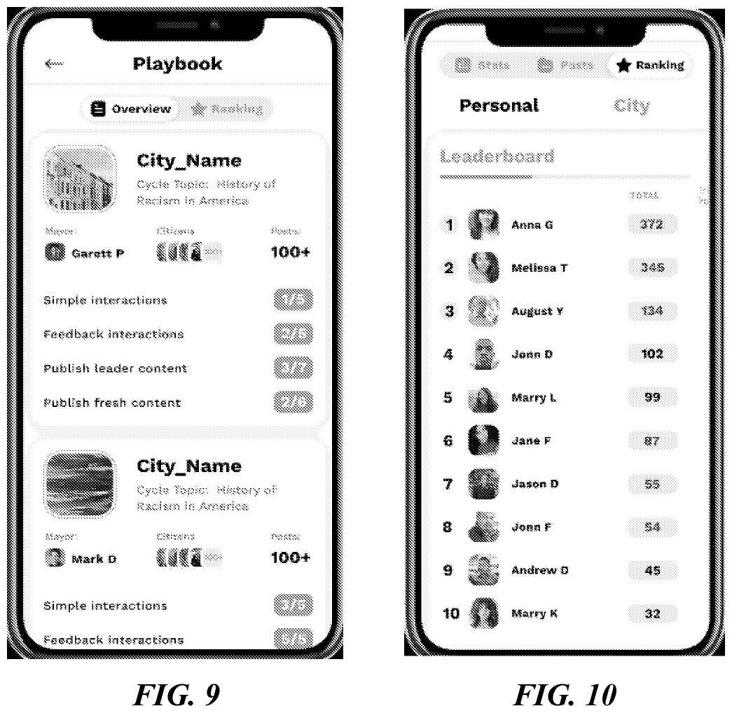

FIG. 9 illustrates the playbook overview interface wherein metrics related to a group's completion of tasks, points earned, and user details are provided. For example, the playbook overview interface may illustrate the total points earned for a city, as well as their progress of activities.

In some embodiments, points may be recorded, tracked, and posted to a leaderboard as shown in FIG. 10. The leaderboard may rank users by points earned, total interactions, or other useful metrics.

FIG. 11 illustrates a screenshot of the QR code interface wherein a QR code is provided to the user to permit the user to join a particular group and interact with the system. The QR code may be shared by a member of the organization to invite other users to join and interact with the system.

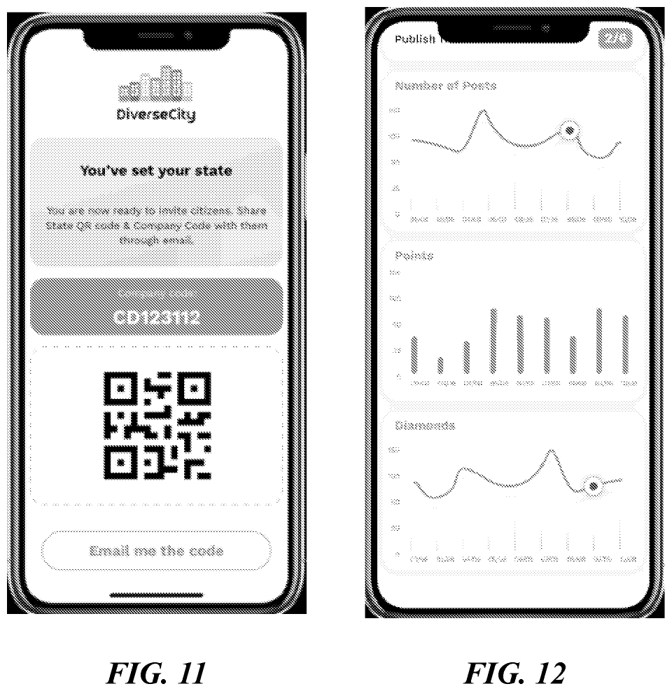

FIG. 12 illustrates a screenshot of the analytics interface which provides analytics corresponding to user (and groups thereof) interactions with the system. For example, the analytics interface may monitor number of posts, points, rewards earned, etc.

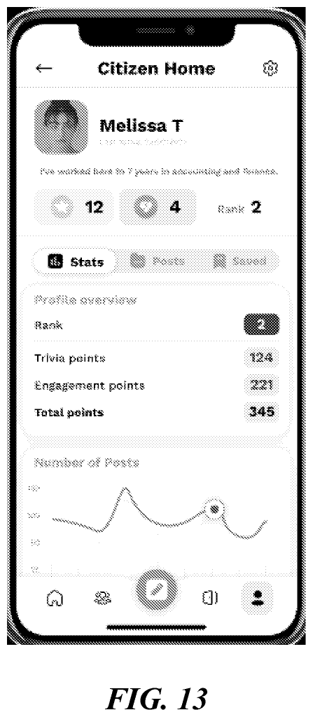

FIG. 13 illustrates a screenshot of the citizen's (i.e., the user's) home interface wherein the citizen can view their rank, points accrued, posts, saved content, rewards received, as well as their personal information. Completed, current, and outstanding tasks may also be viewed by the citizen.

In some embodiments, the system provides a means for an organization to be separated into subgroups which may compete against one another. Separating the organization into subgroups may facilitate the communication between users who may not normally have the opportunity to communicate with one another, while facilitating meaningful interactions and education to promote diversity, equity, and inclusion.

In some embodiments, an engagement engine permits users to accumulate credits (i.e., “Jewels” which allow the user to purchase a good or service from a subject matter expert or other user of the system. For example, the user may receive a discount for content provided by the subject matter expert.

In some embodiments, users' group membership may be shuffled or otherwise changed at pre-defined time intervals. In such, users are given the opportunity to continuously interact with new individuals within the organization.

In some embodiments, the system may be used to disseminate information on any topic, not just diversity, equity, and inclusion. Since all groups within the app are learning about the same topic simultaneously, this could be used for Compliance topics, such as Harassment, Discrimination, Bullying, and other Compliance topics that must be viewed by all employees. The system can allow group members to discuss the topics rather than just view or read about the topics.

In some embodiments, the system can be used to provide company/organization-wide Employee Handbook Training or overviews of Benefits. This may be an annual event in which all employees can participate.

In some embodiments, the system can allow for the creation of Employee Resource Groups (“ERG”), especially in decentralized locations. ERGs are intended to be private groups within organizations that can come together and speak openly about concerns they have or interests they wish to share. With the post-COVID world of working from home, this app allows for this same safe space to occur even when employees are not all in the same location.

In some embodiments, the systems can allow organizations such as schools to use the system is a “Governor-Led” mode (a teacher could be this person) which would allow the administrator to act as a facilitator for ALL cities, sharing content simultaneously and allowing each city to discuss the information within their individual small group setting, Book per Month), the topic is always “Next Book” and the groups pick the book at that time and “study amongst themselves.”

In some embodiments, the system can be used to monitor compliance to initiatives, accreditations, study hours, etc., where the engagement points reflect the company's levels of compliance (i.e., the Goal is to have a given percentage of employees participate in DEI training, and the system can show participating audience) which can be shared with leaders or auditors.

In some embodiments, the system can allow different committees to work together in an asynchronous manner. For example, a Faculty Committee Work, which may be required by accreditors, can be done in the group while making the playbook activities items that are relevant to moving the committee work forward.

In some embodiments, the system may accommodate any topics that an organization wishes to disseminate to their employees/workforce/community participants, including, for example, Financial Literacy, Emotional Intelligence, Onboarding/New Hire Orientation, New Software Training (may be by department), Sales Training, OSHA Training, and any other desired information.

In some embodiments, the system provides improved information dissemination ways including the ability to work/learn/discuss within a group asynchronously and virtually. Participants do not have to be in a room at the same time yet can still share ideas or thoughts about a topic.

In some embodiments, the system offers a mode called “Governor-Led,” which allows a Trainer to disseminate learning topics and assignments to all groups simultaneously, and then allow the participants to “discuss amongst themselves.” In this embodiment, only the Governor level can send out posts that are disseminated to all groups and group members, who can then respond to the posts. Responses by members of a group are only seen by their respective group members.

In some embodiments, the gamification portion may be optional. In this embodiment, points may still accumulate in the background so that the group facilitators and the governor can see engagement, however, members will not see this information to discourage undesired competition or negative comparisons.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

1. An interactive information system comprising:
a user permissions module to assign a group, a role and one or more permissions to each of a plurality of users within an organization;
an activity module to permit the creation and completion of one or more activities; and
an analytics module in operable communication with a user interface module to display metrics related to each of the plurality of users, wherein the metrics are associated with the engagement of the one or more activities.

2. The interactive information system of claim 1, further comprising:
a gamification module to assign engagement points to each of the one or more activities.

3. The system of claim 1, further comprising a communications module to permit communications between each of the plurality of users.

4. The system of claim 2, further comprising a reward module to permit each user to select a reward earned via the accumulation of points.

5. The system of claim 1, wherein the activities include a task.

6. The system of claim 1, further comprising a notifications module to facilitate the transmission of a QR code to invite users to the system.

7. The system of claim 2, further comprising a leaderboard interface to display a leaderboard of users, wherein the leaderboard is established by points accumulated by each user.

8. The system of claim 2 wherein the information system monitors compliance with initiatives, accreditations, or study hours and assigns engagement points based thereon.

9. The system of claim 8 wherein the total engagement points for all users reflects the company's levels of compliance.

10. The system of claim 1, wherein user groups can work together in an asynchronous manner.

11. The system of claim 1, wherein the information system provides information regarding Financial Literacy, Emotional Intelligence, Onboarding/New Hire Orientation, New Software Training, Sales Training, or OSHA Training.

12. The system of claim 1, wherein learning topics and assignments can be disseminated to all groups simultaneously for intragroup discussion.

13. A super-admin portal comprising:
Means for configuring multiple unique instances of an interactive information system, each identified by a unique access code;
Means for configuring, for each instance of the interactive information system, comprising:
a user permissions module to assign a group, a role and one or more permissions to each of a plurality of users within an organization;
an activity module to permit the creation and completion of one or more activities;
a gamification module to assign a point value to each of the one or more activities; and
metrics related to each of the plurality of users, wherein the metrics are associated with the engagement of the one or more activities.

14. The super-admin portal of claim 13 wherein, upon creation of a new access code, the system creates the ability for the application administrator to log into that unique instance of the interactive information system.

15. The super-admin portal of claim 13 wherein the means for configuring further comprises:
an analytics module in operable communication with a user interface module to display metrics related to the plurality of users.

16. The super-admin portal of claim 13 comprising the capability to configure, for each unique instance:
a unique client accesses;
an application administrator;
subject matter experts;
curated content;
tags to group content by key word; and
pre-defined topics and prewritten messages.

17. The super-admin portal of claim 16, wherein the pre-defined topics may be ordered topics for discussion.

18. The super-admin portal of claim 16, wherein the curated content may be assigned to unique clients individually or to all clients globally.

19. A method of configuring an interactive information system comprising:
setting a unique client access ID;
assigning an application administrator;
configuring subject matter experts;
uploading curated content;
configuring tags to group content by keywords; and
configuring pre-defined topics and messages that can deploy to all users of the mobile application upon initial login.

20. The super-admin portal of claim 19, wherein the curated content may be deployed to users based on either individual client-selected choices or content defined as globally deployable to all clients.
